(19) United States
(12) Patent Application Publication
(10) Pub. No.: US 2002/0178662 A1
(43) Pub. Date: Dec. 5, 2002

(54) Came and method of union for leaded glass windows

(76) Inventor: Rafael Velasco Santamaria, Aranda De Duero (Burgos) (ES)

Correspondence Address: COLLARD & ROE, P.C., 1077 Northern Boulevard, Roslyn, NY, 11576-1696, US

(21) Appl. No.: 10/140,701

(22) Filed: May 7, 2002

(30) Foreign Application Priority Data
May 8, 2001 (ES) 200101048

(51) Int. Cl. E06B 3/964

(52) U.S. Cl. 52/204.62

(57) ABSTRACT

A came for constructing glass windows, and a method for using the came. The various glass panes are joined by interposing an I-section came with a special geometry of its center bar and of its top and bottom strips. The came is made of lead. The cross section of the came center bar has staggered notches such that a zigzag shape is obtained. The length of the center bar is greater than the thickness of the glass panes, and insertion of the panes between the free strips is simple. Pressure is applied after the came is interposed between the panes compressing the center bar and reducing the spacing of the notches on its sides.

### OBJECT OF THE INVENTION

The invention here disclosed relates to a came for constructing glass windows, and to the method followed when using said came.

This came has an irregular I-shaped section, comprising two convex strips and a centre rib with a special zigzag configuration.

A property of this came is the approximation of its strips after applying a compression force, due to the folding of its centre rib.

### BACKGROUND OF THE INVENTION

Glass window construction techniques involving union with lead and multiple stained glass parts or panes have been known for centuries.

The earliest construction techniques for these type of glass windows involve placing the parts to be joined on a flat surface, leaving a space between them.

In this space is poured molten lead, forming a run such that when it cools the assembly is consolidated.

The most widespread construction procedure for these glass windows involves the use of an I-section lead came with a centre rib which is longer than the thickness of the glass panes to be joined.

This came is placed between the glass panes to be joined and the space between the top or bottom strips and the glass pane is later filled with a putty.

After the putty is applied, the ends of the came strips are folded by applying a certain pressure, taking advantage of the ductility of lead, thereby closing the space in which the putty is contained.

After this operation the excess putty must be removed.

The present invention relates to a came with a special geometry, which allows assembly and construction of a glass window formed by the union of a number of glass panes in a quick operation which does not require the use of putty.

### DESCRIPTION OF THE INVENTION

The invention object of this document relates to a came and method of union for use in constructing glass windows from a number of glass parts or panes.

These type of glass windows are commonly used to form artistic elements by combining the shape of the panes and their colours.

After the glass panes have been arranged, they must be joined to each other.

The various techniques which involve lead for joining the glass panes do so using a lead run which appears as a thick dark line on the graphical image obtained.

The technique taught in this invention consists of joining the various glass panes by interposing between them an I-section came with a special geometry of its centre bar and of its top and bottom strips.

Said came is made of lead, which provides it with great ductility so that it may be deformed manually to conform to the shape described by the generatrix line of the edges of the glass panes which are to be joined.

Likewise, said ductility allows a simple pressure union as described hereunder.

The cross section of the came centre bar has a number of staggered notches on both of its sides, such that a zigzag shape is obtained.

As the length of the centre bar is greater than the thickness of the glass panes, insertion of said panes between the free strips is simple.

After the came is interposed between the panes a pressure applied on the top and bottom strips compresses the centre bar, reducing the spacing of the notches on its sides.

This compression implies a plastic deformation of the material of the bar, such that when a force is no longer applied the free strips of the came will continue to hold the glass panes placed between them.

In one possible embodiment of the invention the top and bottom strips of the came may have a convex section, so that after the applying the pressure which allows to join the parts a finish is obtained which does not reveal any edges.

The shape of the notches can vary, and may for example be wedge-shaped or have a sinusoidal bar section, such that an applied pressure approximates the folds of the bar by plastic deformation of its material, thereby shortening its length.

The pressure exerted by the deformed came on the glass parts remains after the compression force ends, so that the additional use of putty is not required.

Thus, after a pressure is applied to join the various parts the final window is obtained with a good finish, without requiring subsequent cleaning operations nor touch-ups, with the ensuing saving in time.

### DESCRIPTION OF THE DRAWINGS

The present description is accompanied by a set of drawings, where for purposes of illustration only and in no way meant as a definition of the limits of the invention a preferred embodiment of the invention is represented.

FIG. 1 shows a cross section of the came in an embodiment of the invention.

FIGS. 2 and 3 show the cross section of the same came before and after a pressure is applied to join the parts.

### PREFERRED EMBODIMENT OF THE INVENTION

In view of the above, the present invention relates to a came and method of union for constructing glass windows formed from a number of glass parts with outlines of different shapes.

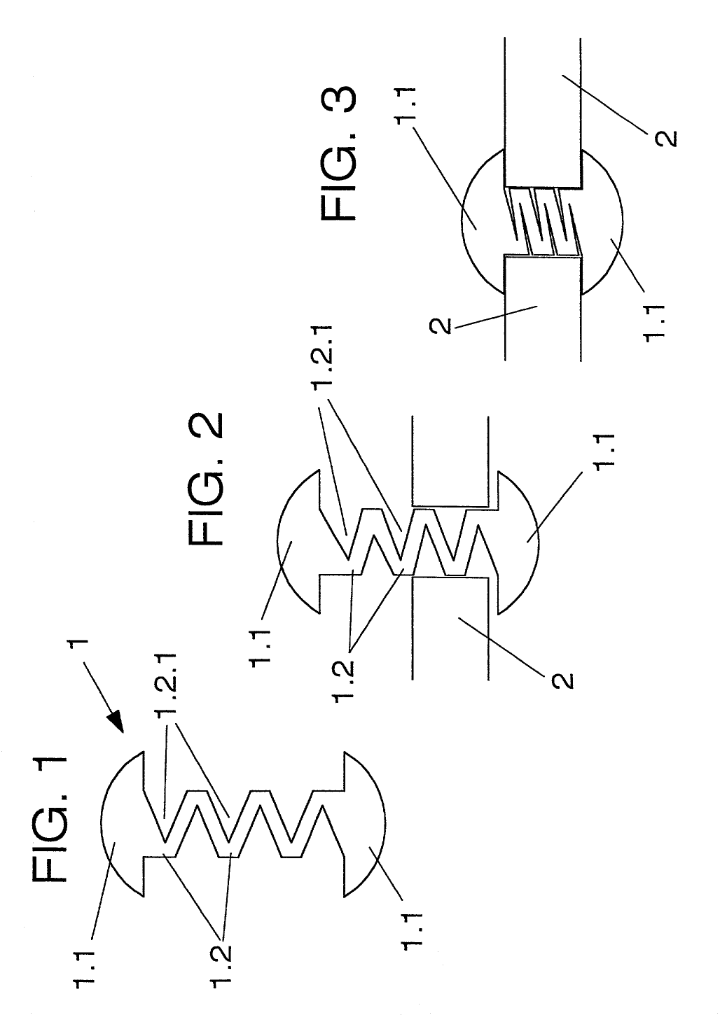

The preferred embodiment involves an I-shaped came (1) as that shown in FIG. 1, comprising a centre bar (1.2) and two strips (1.1), one top strip and one bottom strip.

In this embodiment the strips (1.1) have a convex upper face, while between them is the centre bar (1.2).

Centre bar (1.2) is wide and has notches (1.2.1) on either side, resulting in a zigzag structure.

FIG. 2 shows the arrangement of the glass parts of panes (2) on either side of the came (1).

The centre bar of came (1) has a length greater than the width of glass panes (2) to allow a simple insertion.

After came (1) is placed between the glass panes (2) a force is applied on the external faces of strips (1.1) to compress centre bar (1.2).

The distance between strips (1.1) is shortened as the spacing between the notches (1.2.1) is reduced.

Due to the plastic deformation of centre bar (1.2), the strips (1.1) clamp on the glass panes (2) and thereby join them.

The essence of this invention is unaltered by variations of material, shape, size and arrangement of the component elements, which are described in a non-limiting manner which should allow its reproduction by an expert.

1. Came for joining leaded glass windows from among those glass windows which are formed by glass panes of different shapes, sizes and colours joined by lead to form various patterns, characterised in that said came (1) has an I-shaped cross section with top and bottom strips (1.1) which are preferably convex and a centre bar (1.2)

2. Came for joining leaded glass windows as claimed in claim 1, characterized in that the centre bar (1.2) has a zigzag shape to allow its shortening by compression.

3. Came for joining leaded glass windows as claimed in claim 2, characterised in that the zigzag shape is due to the presence of alternating wedge-shaped lateral notches (1.2.1).

4. Came for joining leaded glass windows as claimed in claim 1 characterised in that the centre bar (1.2) has a zigzag shape which follows a sinusoidal path.

5. Method for joining leaded glass windows according to the previous claims, characterised in that came (1) is placed, in accordance with the previous claims, between two glass panes (2) to be joined and fitted to the centre bar, adapting the direction line of the came to the shape of the antagonistic outlines of the glass panes (2), and in this position applying a force of compression between the top and bottom strips (1.1) until the centre bar (1.2) is compressed and the panes (2) on either side are clamped.
